(19) United States
(12) Patent Application Publication
(10) Pub. No.: US 2026/0331814 A1
(43) Pub. Date: Oct. 22, 2026

(54) CONNECTOR

(71) Applicant: SUMITOMO WIRING SYSTEMS, LTD., Mie (JP)

(72) Inventor: Yusuke YAMOTO, Mie (JP)

(21) Appl. No.: 19/109,568

(22) PCT Filed: Aug. 24, 2023
(86) PCT No.: PCT/JP2023/030404

§ 371 Date: Mar. 7, 2025

(30) Foreign Application Priority Data
Sep. 14, 2022 (JP) 2022-145912

(51) Int. Cl. H01R 13/432

(52) U.S. Cl. CPC H01R 13/432

(57) ABSTRACT

A box portion of a terminal fitting has an inner wall portion defining an internal space, and an outer wall portion arranged to overlap an outer surface of the inner wall portion. The outer wall portion has a return portion covering one end side of a first plate portion of the inner wall portion in a width direction. A lance has an inner locking surface capable of locking to a plate-thickness surface of the first plate portion, an outer locking surface capable of locking to a plate-thickness surface of the return portion, and a tip protrusion that is arranged aligned with the outer locking surface at the other end side of the outer locking surface in the width direction, protrudes further forward than the outer locking surface, and opposes the other end side of the first plate portion in the width direction from an outer side.

### TECHNICAL FIELD

The present disclosure relates to a connector.

### BACKGROUND

The connector described in Patent Document 1 includes a housing that has a cavity (terminal housing hole) in which a lance (terminal locking lance) protrudes, and a terminal fitting that is inserted into the cavity and locked by the lance. The terminal fitting has a tubular box portion (terminal fitting portion). The box portion has a bottom wall, and the bottom wall has a double-wall structure with inner and outer overlap. The lance has a locking surface at a position opposing the plate-thickness surface of the double wall of the bottom wall. The lance also has a tip protrusion that protrudes forward from the locking surface and opposes the outer surface of the outer wall of the double wall. Patent Documents 2 to 5 also disclose connectors that include a terminal fitting that is locked by a lance.

### PRIOR ART DOCUMENT

### Patent Document

Patent Document 1: JP 2015-079721 A
Patent Document 2: JP 2012-209222 A
Patent Document 3: JP H08-148214 A
Patent Document 4: JP 2010-055880 A
Patent Document 5: JP 2021-047995 A

### SUMMARY OF THE INVENTION

### Problems to be Solved

In the case of Patent Document 1, the locking surface of the lance is locked to the plate-thickness surface of a double wall rather than a single wall, and thus the holding force on the terminal fitting can be increased.

However, in the case of Patent Document 1, the locking surface and the tip protrusion are stacked in the height direction, which is the overlapping direction of the double wall, so there is a concern that the size of the lance may increase in the height direction, and consequently the connector may become larger in the height direction.

In view of this, an object of the present disclosure is to provide a connector that is able to increase the holding force on a terminal fitting and avoid enlarging the connector.

### Means to Solve the Problem

A connector of the present disclosure includes a plate-shaped terminal fitting having a tubular box portion and extending in a front-back direction, and a housing having a cavity capable of housing the terminal fitting and an elastically deformable lance protruding forward from an inner wall of the cavity, in which the box portion includes an inner wall portion defining an internal space and an outer wall portion arranged to overlap an outer surface of the inner wall portion, the inner wall portion has a first plate portion along a width direction intersecting an overlapping direction of the inner wall portion and the outer wall portion and the front-back direction, the outer wall portion has a return portion covering one end side of the first plate portion in the width direction, and the lance has an inner locking surface capable of locking to a plate-thickness surface of the first plate portion, an outer locking surface capable of locking to a plate-thickness surface of the return portion, and a tip protrusion that is arranged aligned with the outer locking surface at the other end side of the outer locking surface in the width direction, protrudes further forward than the outer locking surface, and opposes the other end side of the first plate portion in the width direction from an outer side.

### Effect of the Invention

According to the present disclosure, it is possible to provide a connector that can increase the holding force on a terminal fitting and avoid enlarging of the connector.

### BRIEF DESCRIPTION OF THE DRAWINGS

FIG. 1 is a side view of a connector according to a first embodiment of the present disclosure, cut away on the housing side to show a state in which a terminal fitting is inserted into a cavity of the housing and arranged so as to be capable of locking to a lance.

FIG. 2 is a cross-sectional view taken along line A-A in FIG. 1.

FIG. 3 is a diagram corresponding to FIG. 2, showing a state in which a rearward pulling force acts on the terminal fitting and the lance is displaced in the reverse direction.

FIG. 4 is a side cross-sectional view of the state shown in FIG. 1.

FIG. 5 is a perspective view of a front portion of the terminal fitting as seen obliquely from below.

FIG. 6 is a front view showing a guide portion formed on an opening edge of the cavity on the front surface of the housing.

FIG. 7 is a perspective view of the lance protruding inside the cavity as seen obliquely from the upper right.

FIG. 8 is a perspective view of the lance protruding inside the cavity as seen obliquely from the upper left.

### DETAILED DESCRIPTION TO EXECUTE THE INVENTION

### Description of Embodiments of Present Disclosure

First, embodiments of the present disclosure will be listed and described.
(1) A connector of the present disclosure includes: a plate-shaped terminal fitting having a tubular box portion and extending in a front-back direction, and a housing having a cavity capable of housing the terminal fitting and an elastically deformable lance protruding forward from an inner wall of the cavity, in which the box portion includes an inner wall portion defining an internal space and an outer wall portion arranged to overlap an outer surface of the inner wall portion, the inner wall portion has a first plate portion along a width direction intersecting an overlapping direction of the inner wall portion and the outer wall portion and the front-back direction, the outer wall portion has a return portion covering one end side of the first plate portion in the width direction, and the lance has an inner locking surface capable of locking to a plate-thickness surface of the first plate portion, an outer locking surface capable of locking to a plate-thickness surface of the return portion, and a tip protrusion that is arranged aligned with the outer locking surface at the other end side of the outer locking surface in the width direction, protrudes further forward than the outer locking surface, and opposes the other end side of the first plate portion in the width direction from an outer side.

When a rearward pulling force acts on the terminal fitting, the inner locking surface of the lance is locked to the plate-thickness surface of the first plate portion, and the outer locking surface of the lance is also locked to the plate-thickness surface of the return portion, thus enabling the holding force on the terminal fitting to be increased. Also, the tip protrusion abuts against the first plate portion, thereby enabling displacement of the lance in the reverse direction and backward movement of the terminal fitting to be suppressed. Furthermore, the tip protrusion and the outer locking surface are arranged aligned with each other in the width direction, and thus there is no increase in the size of the lance in the height direction, and consequently enlargement of the connector can be avoided.
(2) The lance preferably includes a lance body coupled to the inner wall of the cavity and extending in the front-back direction, and a locking protrusion protruding from the lance body toward an inner side of the cavity, the inner locking surface is preferably arranged on a front surface of the locking protrusion, and the outer locking surface and the tip protrusion are preferably arranged aligned with each other in the width direction on a front surface of the lance body.

The inner locking surface is arranged on the front surface of the locking protrusion, and thus a large locking margin can be secured on the plate-thickness surface of the first plate portion. Since the front surface of the lance body is cut out, the return portion enters the cutout portion, enabling the locked state of the lance and the return portion to be stabilized.

(3) Positions of respective widthwise center portions of the box portion and the locking protrusion preferably coincide with each other inside the cavity.

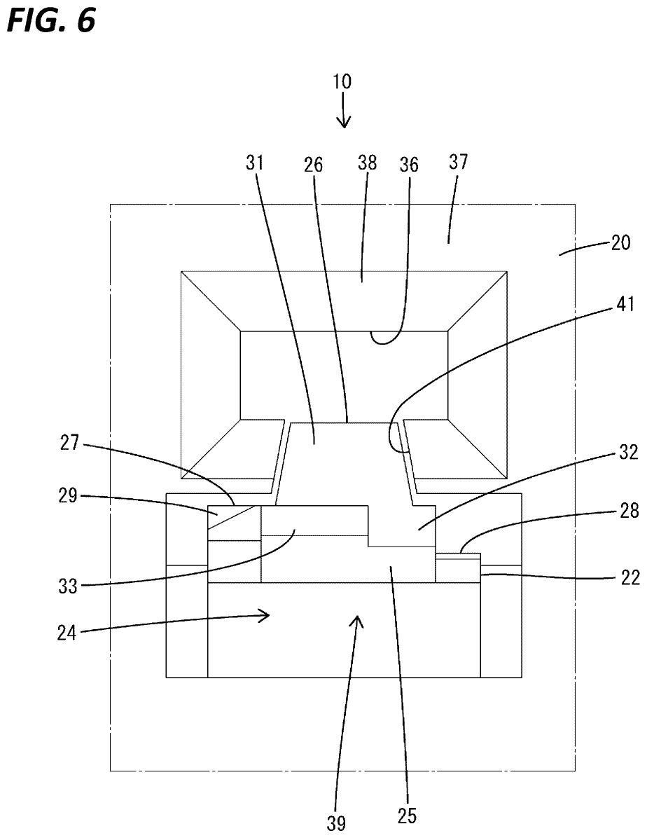

Since the locking protrusion is not shifted (offset) in the width direction relative to the box portion, a die-cut hole portion for molding the locking protrusion (cutout portion 41 in the first embodiment described below; see FIG. 6) can be properly formed in a guiding shape for a mating terminal fitting on the front surface of the housing in a widthwise center portion.

(4) The box portion preferably has a second plate portion at a position opposing the first plate portion, and the second plate portion preferably has an excessive deflection restricting portion bent at a rear end portion thereof to face the lance side.

When a rearward pulling force acts on the terminal fitting, the lance abuts against the excessive deflection restricting portion, thereby enabling excessive deflection of the lance to be suppressed.

### DETAILED DESCRIPTION OF EMBODIMENTS OF DISCLOSURE

Specific examples of the present disclosure will be described below with reference to the drawings. Note that the present invention is indicated by the claims rather than being limited to these illustrative examples, and all changes that come within the meaning and range of equivalency of the claims are intended to be embraced therein.

### First Embodiment

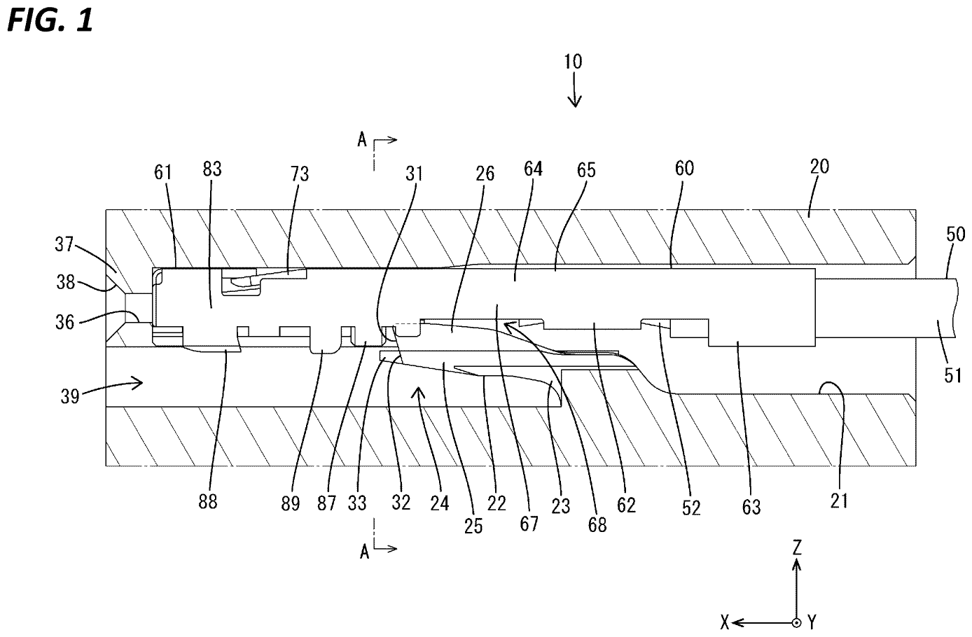

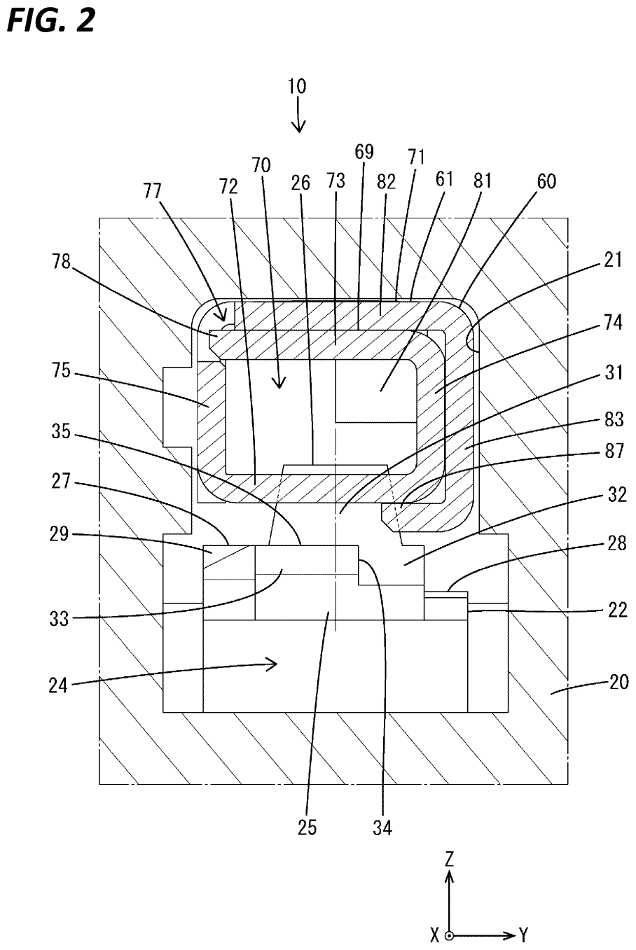

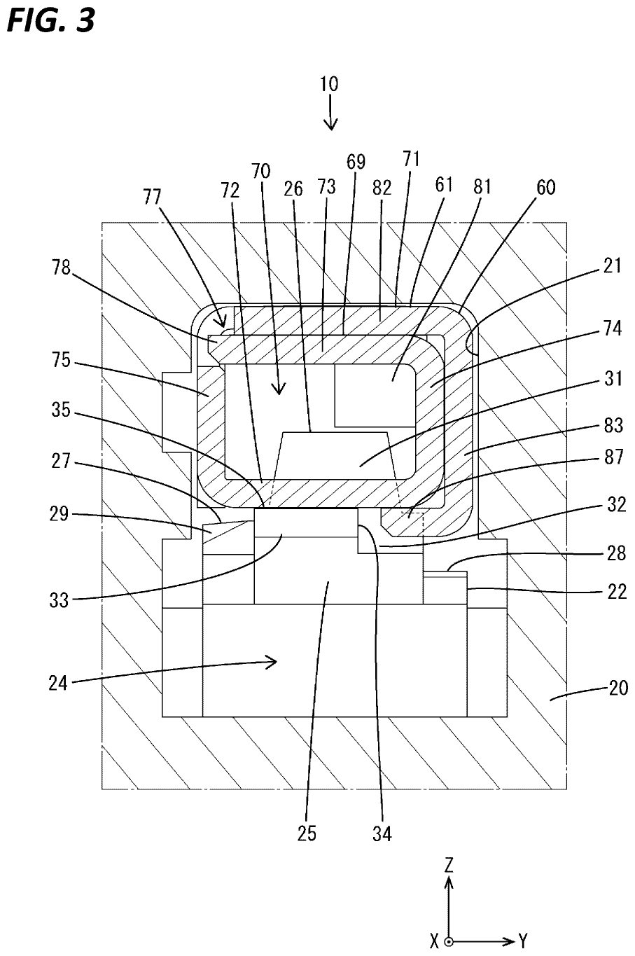

A connector 10 according to a first embodiment includes a housing 20 made of a synthetic resin and a terminal fitting 60 made of a conductive metal. As shown in FIG. 1, the terminal fitting 60 is housed in the housing 20. The housing 20 is configured to be fitted to a mating housing (not shown). In the following description, the side of the housing 20 opposing a mating connector at the start of fitting will, in relation to the front-back direction, be referred to as the front side. The up-down direction is referenced on the up-down direction in each diagram. The left-right direction is referenced on the left-right direction in FIGS. 2 and 3. In FIGS. 1 to 3, the front side, the right side, and the upper side are shown by the symbols “X”, “Y”, and “Z”, respectively. The up-down direction and the left-right direction are synonymous with the height direction and the width direction, respectively. These directional references are merely for convenience and will not necessarily coincide with directional references in a state where the connector 10 is installed in a vehicle (not shown) or the like.

### Terminal Fitting

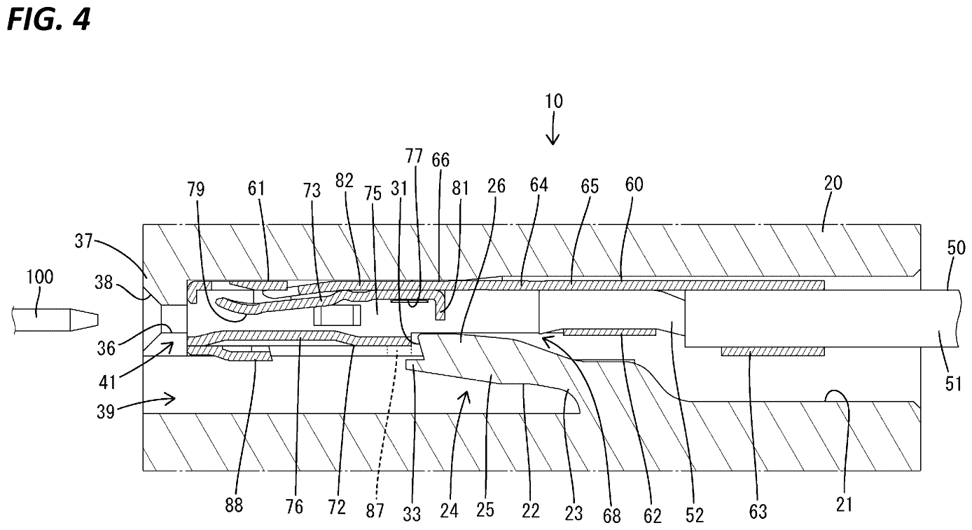

The terminal fitting 60 is formed by a process such as bending a single metal plate into a shape elongated in the front-back direction as shown in FIGS. 1 and 4. The terminal fitting 60 has a box portion 61 on the front side, barrel portions 62 and 63 on the rear side, and a coupling portion 64 between the box portion 61 and the barrel portions 62 and 63. The terminal fitting 60 also has a band-shaped base portion 65 extending over an entire length thereof in the front-back direction. The base portion 65 constitutes a part of each of the box portion 61, the coupling portion 64, and the barrel portions 62 and 63.

The barrel portions 62 and 63 include a wire barrel portion 62 on the front side and an insulation barrel portion 63 on the rear side. The wire barrel portion 62 is crimped and electrically connected to a core wire 52 exposed by removing a coating 51 at the end portion of an electric wire 50. The insulation barrel portion 63 is crimped and mechanically connected to the coating 51 at the end portion of the electric wire 50.

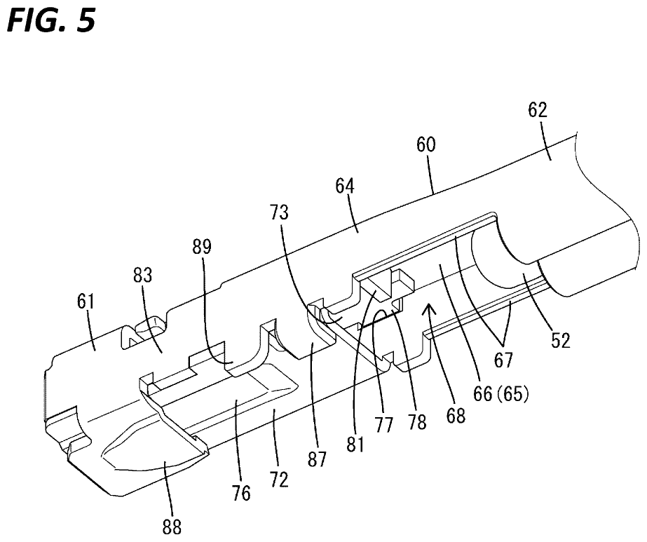

As shown in FIG. 5, the coupling portion 64 has a band plate-shaped coupling body portion 66 extending in the front-back direction, and a pair of side portions 67 that are bent downward from both right and left ends of the coupling body portion 66 and arranged parallel to each other. The coupling body portion 66 constitutes an intermediate portion of the base portion 65 in the front-back direction. The rear ends of the side portions 67 are coupled to the wire barrel portion 62. The front ends of the side portions 67 are respectively coupled to a fourth plate portion 75 and a sixth plate portion 83, which will be described later. The space below the coupling portion 64 forms a receiving space 68 into which a locking protrusion 26 of a lance 22 described later can enter.

The box portion 61 has a rectangular tubular shape, and, as shown in FIGS. 2 and 3, has an inner wall portion 69 that defines an internal space 70, and an outer wall portion 71 that is arranged along the outer surface of the inner wall portion 69 radially outside of the inner wall portion 69. The inner wall portion 69 has a first plate portion 72 that is arranged along the left-right direction, a second plate portion 73 that is arranged above the first plate portion 72 and parallel to the first plate portion 72, a third plate portion 74 that extends in the up-down direction and joins to the right ends of the first plate portion 72 and the second plate portion 73, and a fourth plate portion 75 that rises from the left end of the first plate portion 72 and is arranged parallel to the third plate portion 74.

As shown in FIG. 4, the first plate portion 72 has a receiving portion 76 in an intermediate portion in the front-back direction that is shaped to bulge toward the internal space 70. The upper surface of the receiving portion 76 is arranged along the front-back direction.

As shown in FIGS. 2, 3 and 5, the second plate portion 73 has a fixing portion 78 that overhangs leftward near the rear end portion and enters a fixing hole 77 formed in the upper left corner portion of the box portion 61. The second plate portion 73 is shaped to extend forward from the fixing hole 77 in a cantilever shape and has a contact portion 79 that protrudes downward at the front end side as shown in FIG. 4. The second plate portion 73 is elastically deformable in the up-down direction with the fixing hole 77 side that enters the fixing hole 77 as a supporting point. When the housing 20 is fitted to the mating housing, a male tab 100 of the mating terminal fitting enters between the contact portion 79 of the second plate portion 73 and the receiving portion 76 from the front side, and the contact portion 79 is electrically connected to the male tab 100 while the second plate portion 73 is in an elastically deformed state.

As shown in FIGS. 4 and 5, the rear end portion of the second plate portion 73 is arranged along the inner surface of the coupling body portion 66. The second plate portion 73 has, at a rear end portion, an excessive deflection restricting portion 81 that is bent downward and hangs down. As shown in FIGS. 2 and 3, the excessive deflection restricting portion 81 has a rectangular shape in front view and is arranged at the upper right side of the internal space 70. The lower end of the excessive deflection restricting portion 81 faces the receiving space 68 above the lower ends of the side portions 67 (see FIG. 5).

As shown in FIGS. 2 and 3, the outer wall portion 71 has a fifth plate portion 82 that extends rightward from the upper end of the fourth plate portion 75 and overlaps the outer surface (upper surface) of the second plate portion 73, the sixth plate portion 83 that extends downward from the right end of the fifth plate portion 82 and overlaps the outer surface (right surface) of the third plate portion 74, and a return portion 87 that bends leftward and extends a short distance from the lower end of the rear end portion of the sixth plate portion 83.

As shown in FIG. 5, the return portion 87 overlaps the outer surface of the rear end portion of the first plate portion 72 so as to partially cover the outer surface (lower surface) of the right end side (one end side in the width direction) of the rear end portion of the first plate portion 72. The rear end surface (plate-thickness surface) of the return portion 87 and the rear end surface (plate-thickness surface) of the first plate portion 72 are aligned with each other at the same position in the front-back direction (see FIG. 4).

As shown in FIG. 5, the outer wall portion 71 has a front plate portion 88 that extends leftward from the lower end of the front end portion of the sixth plate portion 83 and overlaps the outer surface of the front end portion of the first plate portion 72. The sixth plate portion 83 has a protruding piece 89 that protrudes downward at a position near the rear end portion. The protruding piece 89 is arranged in front of the return portion 87 with the plate surface oriented in the left-right direction. The protruding piece 89 can function as a stabilizer that guides insertion of the terminal fitting 60 into the housing 20.

### Housing

As shown in FIGS. 1 and 4, the housing 20 has a cavity 21 extending in the front-back direction. The front and rear ends of the cavity 21 are open on the front and rear surfaces of the housing 20, respectively. Although not shown, a plurality of cavities 21 are formed in the housing 20. In addition, although not shown, the housing 20 has a lock arm that locks a mating housing and holds the housing 20 and the mating housing in a fitted state.

The housing 20 has the lance 22 that protrudes forward from the lower surface of the inner wall of the cavity 21. The lance 22 is elastically deformable in the up-down direction with a base end 23 coupled to the lower surface of the inner wall of the cavity 21 as a supporting point. The cavity 21 has a deflection space 24 below the lance 22 that allows elastic displacement of the lance 22.

The lance 22 has a lance body 25 that extends forward from the base end 23, and a locking protrusion 26 that protrudes from the upper surface of the lance body 25 into the cavity 21.

As shown in FIG. 6, a first press surface 27 and a second press surface 28 are formed on the upper surface of the lance body 25 at both right and left ends with the locking protrusion 26 therebetween. The first press surface 27 and the second press surface 28 are arranged along the front-back direction and are pressed by a jig (not shown) when unlocking the lance 22.

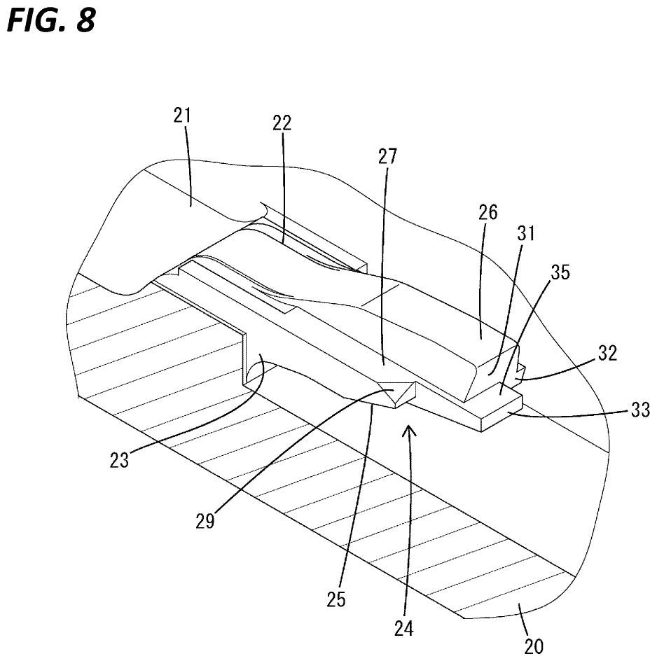

As shown in FIG. 8, the lance body 25 has a guide inclined surface 29 with a notched front end corner portion at the upper left. The guide inclined surface 29 joins to the first press surface 27 and serves to guide the jig to the first press surface 27.

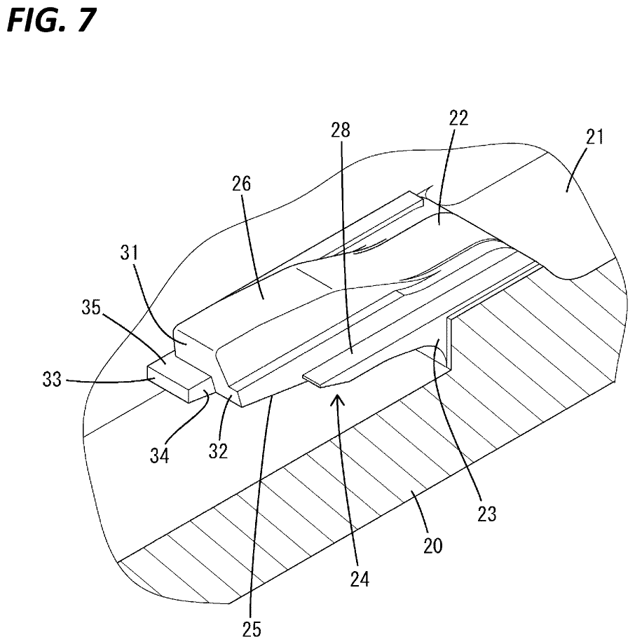

The second press surface 28 is arranged at a lower position than the first press surface 27 as shown in FIG. 6, in order to avoid interference with the protruding piece 89 of the terminal fitting 60. As shown in FIGS. 7 and 8, the rear surface of the locking protrusion 26 has an inclined shape that inclines forward. The front surface of the locking protrusion 26 is configured as an inner locking surface 31 capable of locking the rear end surface (plate-thickness surface) of the first plate portion 72 of the terminal fitting 60. The inner locking surface 31 is arranged along the left-right direction and along a direction that inclines with respect to the up-down direction so that the upper end side protrudes forward as shown in FIGS. 1 and 4. Also, as shown in FIG. 6, the inner locking surface 31 has a trapezoidal shape in front view that widens toward the lower end, and is arranged in a center portion of the lance 22 in the left-right direction.

As shown in FIG. 6, the front surface of the lance body 25 has an outer locking surface 32 capable of locking the rear end surface (plate-thickness surface) of the return portion 87 of the terminal fitting 60. The outer locking surface 32 is continuous with the inner locking surface 31 below the inner locking surface 31 without a step and is arranged further forward and leftward than the second press surface 28. The outer locking surface 32 is arranged on the front surface of the lance body 25, biased to the right from the center portion of the lance body 25 in the left-right direction. The left-right dimension (width dimension) of the outer locking surface 32 is smaller than the left-right dimension of the inner locking surface 31. Also, as shown in FIG. 1, the outer locking surface 32 has the upper end side inclined forward and is continuous from the inner locking surface 31 at the same inclination angle.

As shown in FIGS. 6 to 8, the lance body 25 has a tip protrusion 33 that protrudes further forward than the outer locking surface 32 at a position on the left of the outer locking surface 32 and aligned with the outer locking surface 32 in the left-right direction. The tip protrusion 33 is plate piece-shaped and aligned with the outer locking surface 32 in the left-right direction. The tip protrusion 33 and the outer locking surface 32 are positioned to overlap each other in the up-down direction. Specifically, the outer locking surface 32 is positioned within the vertical formation range of the tip protrusion 33 in the up-down direction. The lower end of the outer locking surface 32 intersects the lower surface of the lance body 25 (surface facing the deflection space 24).

The outer locking surface 32 is arranged so as to intersect and join to the right side surface of the tip protrusion 33. As shown in FIG. 7, the lance body 25 has a notched recess 34 with an L-shaped cross section formed by the right side surface of the tip protrusion 33 and the outer locking surface 32.

As shown in FIGS. 2 and 3, the upper surface of the tip protrusion 33 forms an opposing surface 35 that opposes the outer surface (lower surface) of the first plate portion 72 of the terminal fitting 60 in a contactable manner. As shown in FIG. 8, the opposing surface 35 of the tip protrusion 33 is a flat surface that intersects the inner locking surface 31 and joins to the first press surface 27 along the front-back direction without a step.

As shown in FIGS. 1 and 6, the housing 20 has a front wall 37 that closes the front side of the cavity 21 except for a tab insertion hole 36. The front surface of the front wall 37 has a guide portion 38 that expands in a tapered shape from the opening of the tab insertion hole 36. The guide portion 38 serves to guide the male tab 100 of the mating terminal fitting into the tab insertion hole 36. Although not shown, the male tab 100 is inserted through the tab insertion hole 36 into the box portion 61 of the terminal fitting 60 arranged in the cavity 21 and connected.

The front surface of the housing 20 has a punch hole 39 resulting from the removal of a die (not shown) for forming the lance 22. The punch hole 39 communicates with the deflection space 24 inside the housing 20. As shown in FIG. 6, the punch hole 39 includes the cutout portion 41 formed by cutting out an intermediate portion of the lower end portion of the guide portion 38 in the left-right direction. The inner locking surface 31 of the locking protrusion 26 is visible from the front through the cutout portion 41.

### Operation of Connector

The terminal fitting 60 is inserted into the cavity 21 of the housing 20 from the rear, in a state where the electric wire 50 is connected to the barrel portions 62 and 63. In the process of inserting the terminal fitting 60, the box portion 61 slides on the rear surface of the locking protrusion 26, and the lance 22 elastically deforms into the deflection space 24. As shown in FIGS. 1 and 4, when the box portion 61 abuts against the rear surface of the front wall 37 and reaches a position where the insertion of the terminal fitting 60 is stopped (normal insertion position), the lance 22 elastically returns to its original position and the locking protrusion 26 enters the receiving space 68, with the inner locking surface 31 of the locking protrusion 26 thus being arranged opposing the rear end surface of the box portion 61 in a contactable manner. Specifically, as shown in FIG. 2, the upper end portion of the inner locking surface 31 of the locking protrusion 26 is arranged opposing the rear end surface of an intermediate portion of the first plate portion 72 in the left-right direction in a contactable manner along the left-right direction, and the lower right end portion of the inner locking surface 31 of the locking protrusion 26 is arranged opposing the left end portion of the return portion 87 in a contactable manner. When the box portion 61 abuts against the rear surface of the front wall 37 and the lance 22 is in its natural state, the outer locking surface 32 is arranged below and away from the return portion 87. The lower end of the excessive deflection restricting portion 81 is arranged opposing the upper surface of the locking protrusion 26.

In the above state, a backward pulling force may act on the terminal fitting 60 due, for instance, to the electric wire 50 led out from the housing 20 being pulled backward. When such a pulling force acts on the terminal fitting 60, the terminal fitting 60 moves backward from the state shown in FIGS. 1 and 4, and the rear end surface of the box portion 61 reaches a position where it contacts the inner locking surface 31 of the locking protrusion 26. When the pulling force continues to act and the terminal fitting 60 further moves backward, the rear end surface of the first plate portion 72 slides toward the lower end portion of the inner locking surface 31, and the lance 22 elastically deforms upward, that is, in the reverse direction. Accordingly, as shown in FIG. 3, the rear end surface of the first plate portion 72 is locked to the lower end portion of the inner locking surface 31 over a wide area along the left-right direction. Also, the return portion 87 enters the inside of the notched recess 34, and the rear end surface of the return portion 87 is locked to the outer locking surface 32. This restricts the terminal fitting 60 from moving backward any further and prevents the terminal fitting 60 from coming out of the cavity 21. At this time, the opposing surface 35 of the tip protrusion 33 abuts against the outer surface (lower surface) of the rear end portion of the first plate portion 72. Furthermore, the upper surface of the locking protrusion 26 can also abut against the lower end of the excessive deflection restricting portion 81. Backward movement of the terminal fitting 60 is thus also restricted due to the lance 22 abutting against the first plate portion 72 and the excessive deflection restricting portion 81 in this manner and upward displacement of the lance 22 being suppressed. As a result, the terminal fitting 60 is reliably prevented from coming out of the cavity 21.

As described above, according to the first embodiment, when a rearward pulling force acts on the terminal fitting 60, the inner locking surface 31 of the lance 22 is locked to the rear end surface of the first plate portion 72, and the outer locking surface 32 of the lance 22 is also locked to the rear end surface of the return portion 87, thus enabling the holding force on the terminal fitting 60 to be increased. Also, the opposing surface 35 of the tip protrusion 33 abuts against the outer surface (lower surface) of the first plate portion 72, thereby enabling upward displacement of the lance 22 and backward movement of the terminal fitting 60 to be reliably suppressed. Furthermore, since the tip protrusion 33 and the outer locking surface 32 are aligned in the left-right direction and not in the height direction, there is no increase in the size of the lance 22 in the height direction, and consequently enlargement of the connector 10 can be avoided.

The inner locking surface 31 is arranged on the front surface of the locking protrusion 26, and thus a large locking margin can be secured on the rear end surface of the first plate portion 72. Also, the return portion 87 enters the notched recess 34 of the lance body 25, thereby enabling the locked state of the lance 22 and the return portion 87 to be stabilized.

Furthermore, in the first embodiment, the respective center portions of the box portion 61 and the locking protrusion 26 in the left-right direction are located at the same position in the left-right direction, as shown in FIGS. 2 and 3. Therefore, the locking protrusion 26 is not shifted (offset) in the left-right direction with respect to the box portion 61, and the cutout portion 41 can be formed in a center portion (intermediate portion) of the lower end portion of the guide portion 38 in the left-right direction, as shown in FIG. 6. This allows the guide portion 38 to properly exhibit the function of guiding the male tab 100.

When a rearward pulling force acts on the terminal fitting 60, the lance 22 also abuts against the excessive deflection restricting portion 81, thereby enabling excessive deflection of the lance 22 to be suppressed.

### Other Embodiments of Disclosure

The above-described first embodiment disclosed herein is to be considered in all respects as illustrative and not restrictive.

In the above-described first embodiment, the inner locking surface and the outer locking surface are continuously arranged on the lance without a step. In contrast, according to another embodiment, the inner contact surface and the outer locking surface may be arranged on the lance via a step.

In the above-described first embodiment, the inner locking surface is arranged with an incline on the front surface of the locking protrusion. In contrast, the inner locking surface may be arranged along the up-down direction on the front surface of the locking protrusion.

### LIST OF REFERENCE NUMERALS

10 Connector
20 Housing
21 Cavity
22 Lance
23 Base end
24 Deflection space
25 Lance body
26 Locking protrusion
27 First press surface
28 Second press surface
29 Guiding inclined surface
31 Inner locking surface
32 Outer locking surface
33 Tip protrusion
34 Notched recess
35 Opposing surface
36 Tab insertion hole
37 Front wall
38 Guide portion
39 Punch hole
41 Cutout portion
50 Electric wire
51 Coating
52 Core wire
60 Terminal fitting
61 Box portion
62 Wire barrel portion (barrel portion)
63 Insulation barrel portion (barrel portion)
64 Coupling portion
65 Base portion
66 Coupling body portion
67 Side portion
68 Receiving space
69 Inner wall portion
70 Internal space
71 Outer wall portion
72 First plate portion
73 Second plate portion
74 Third plate portion
75 Fourth plate portion
76 Receiving portion
77 Fixing hole
78 Fixing portion
79 Contact portion
81 Excessive deflection restricting portion
82 Fifth plate portion
83 Sixth plate portion
87 Return portion
88 Front plate portion
89 Protruding piece
100 Male tab

1. A connector comprising:
a plate-shaped terminal fitting having a tubular box portion and extending in a front-back direction; and
a housing having a cavity capable of housing the terminal fitting and an elastically deformable lance protruding forward from an inner wall of the cavity,
wherein the box portion has an inner wall portion defining an internal space and an outer wall portion arranged to overlap an outer surface of the inner wall portion,
the inner wall portion has a first plate portion along a width direction intersecting an overlapping direction of the inner wall portion and the outer wall portion and the front-back direction,
the outer wall portion has a return portion covering one end side of the first plate portion in the width direction, and
the lance includes:
an inner locking surface capable of locking to a plate-thickness surface of the first plate portion;
an outer locking surface capable of locking to a plate-thickness surface of the return portion; and
a tip protrusion that is arranged aligned with the outer locking surface at the other end side of the outer locking surface in the width direction, protrudes further forward than the outer locking surface, and opposes the other end side of the first plate portion in the width direction from an outer side.

2. The connector according to claim 1,
wherein the lance includes:
a lance body coupled to the inner wall of the cavity and extending in the front-back direction; and
a locking protrusion protruding from the lance body toward an inner side of the cavity,
the inner locking surface is arranged on a front surface of the locking protrusion, and
the outer locking surface and the tip protrusion are arranged aligned with each other in the width direction on a front surface of the lance body.

3. The connector according to claim 2, wherein positions of respective widthwise center portions of the box portion and the locking protrusion coincide with each other inside the cavity.

4. The connector according to claim 1,
wherein the box portion has a second plate portion at a position opposing the first plate portion, and
the second plate portion has an excessive deflection restricting portion bent at a rear end portion thereof to face the lance side.
